(19) United States
(12) Patent Application Publication
(10) Pub. No.: US 2004/0199334 A1
(43) Pub. Date: Oct. 7, 2004

(54) Method for generating a quantitative structure property activity relationship

(76) Inventors: Istvan Kovesdi, Budapest (HU); Gyorgy Keri, Budapest (HU); Lazlo Orfi, Budapest (HU)

Correspondence Address: Leon R Yankwich, Yankwich & Associates, 201 Broadway, Cambridge, MA, 02139, US

(21) Appl. No.: 10/474,143

(22) PCT Filed: Apr. 2, 2002
(86) PCT No.: PCT/EP02/03622

Related U.S. Application Data
(60) Provisional application No. 60/285,222, filed on Apr. 23, 2001.

(30) Foreign Application Priority Data
Apr. 6, 2001 (EP) 01108737.6

(51) Int. Cl. G06F 19/00; G06G 7/48

(52) U.S. Cl. 702/27; 703/11

(57) ABSTRACT

The present invention relates to a method for generating a quantitative structure property activity relationship (QSPAR) between the structure of chemical compounds and their pharmacological activity. Said method comprises the steps of establishing at least one database containing molecular descriptors especially 2D and/or 3D biological/physical/chemical data; selecting significant descriptors according to their influence to said structure property activity relationship; providing at least a model for generating a quantitative structure property activity relationship; verifying said model by the use of at least one quality parameter; and repeating steps b, c, and d until said quality parameter reaches a predetermined value. The method is especially useful for the correlation of chemical compounds with large differences in structure. Furthermore, a system for generating a quantitative structure property activity relationship (QSPAR) between the structure of chemical compounds and their pharmacological activity is disclosed.

The present invention relates to a method for generating a Quantitative Structure Property Activity Relationship (QSPAR) and a system for generating a Quantitative Structure Property Activity Relationship (QSPAR) between the structure of chemical compounds and their pharmacological activity. Especially, the present invention is directed to an automatic method for the recognition of validated Quantitative Structure—physico-chemical Properties—biological Activity—Relationships (QSPAR) and the application of the recognized relationships for the quantitative prediction of biological activity and/or physico-chemical properties of compounds.

### BACKGROUND OF THE INVENTION

In an endless search for new and more active pharmaceutical compounds for prophylaxis and/or treatment of various diseases, one approach to discover new pharmaceutically active compounds uses mass screening of naturally occurring chemical compounds or compound libraries synthesized by combinatorial chemistry. However, once a pharmaceutically active compound has been identified, a search to further chemical compounds closely or remotely related to said identified chemical compound must still be conducted in order to find molecules with higher activity and/or minor toxic properties or side effects within a given biological system. One of the principal techniques which has been employed by medicinal chemists is to examine the chemical structures of a series of chemical compounds which are related by the fact that they all exhibit some pharmacological activity in a given biological system, and, relying on fundamental chemical and physical principles, predictions can be made, which substituents and/or residues of the molecule are most important for the biological activity. Based on these predictions, new compounds can be designed, synthesized, and submitted to biological tests. A normal drawback of said methods is that predictions can only be made for chemical compounds which are in close relation to the examined test molecules. That means, the new designed chemical compounds have to have similar structure and properties like the examined test compounds.

Rational drug research applies sophisticated methods for chemical structure/biological activity correlation studies (MLR, PLS, ANN, CoMFA etc.).

The PCT application 00/39578 is directed to a method for estimating the cell count in a body fluid by the use of multivariate chemometric methods, such as MLR, PLS, or ANN, for deriving properties and/or concentrations from spectral information.

Multivariate Linear Regression (MLR) is fast but limited to linear and pseudo linear modeling. MLR determines the linear relation between the matrix of explanatory variables and the matrix of responses. Most conventional software packages of MLR cannot handle those situations, where the number of molecules is either smaller or larger than the number of explanatory variables. The MLR implementation used within the present invention does not have such limitations. It always gives a unique solution which has the smallest Frobenius norm. However, in the case of correlated inputs/outputs and/or limited observations, MLR methods usually fail to give a model which is robust to noise and which does not overfit.

MLR is the traditional mathematical method applied in the development of QSAR [C. Hansch, T. Fujita, J. Am. Chem. Soc., 1964, 86, 1616-1620; C. Hansch, C. Silipo, J. Am. Chem. Soc., 1975, 97, 6849-6861]. Regression sometimes results in QSAR models exhibiting instability when trained with noisy data or when some of the descriptors are strongly correlated or with limited number of observations. In addition, traditional regression techniques often require subjective decisions as the likely functional (e.g. quadratic) relationships between structure derived descriptors and activity. The variable selection in regression methods is usually based upon the statistical figures of the data fitting. The results of these types of variable selections are generally quite inadequate when one checks them with cross validation.

The PCT application WO 92/22875 describes the Comparative Molecular Field Analysis (CoMFA) as an effective computer implemented methodology of 3D-QSAR employing both, interactive graphics and statistical techniques for correlating shapes of molecules with their observed biological properties. During this process the steric and electrostatic interaction energies for each molecule of a series of known substrates with a test probe atom are calculated at spatial coordinates around the molecule. Subsequent analysis of the data table by partial least squares (PLS) cross-validation techniques yields a set of coefficients which reflect the relative contribution of the shape elements of the molecular series to differences in biological activities.

Comparative Molecular Field Approach (CoMFA) is a heuristic procedure for defining, manipulating, and displaying the differences in molecular fields surrounding molecules which are responsible for observed differences in the activity of said molecules. Once a series of molecules, for which the same biological interaction parameter has been measured, is chosen for analysis, the three-dimensional structure for each molecule is obtained, typically from the Cambridge Crystallographic Database or by standard molecular modeling techniques. The 3D structure for the first molecule is placed within a 3D lattice so that the positional relationship of each atom of the molecule to a lattice intersection (grid point) is known. A probe atom is chosen, placed successively at each lattice intersection, and the steric and electronic interaction energies between the probe atom and the molecule calculated for all lattice intersections. These calculated energies form a row in a conformer data table associated with that molecule. CoMFA works by comparing the interaction energy descriptors of shape and relating changes in shape to differences in measured biological activity.

CoMFA became one of the most popular method for QSAR recently. It uses multivariate statistical methods for correlating shapes and properties of structures with their biological activity. Bioactive conformation of each compound is aligned and superimposed according to the supposed binding to the receptor. This method also assumes great similarity between the structures otherwise they could not be superimposed. CoMFA compares the 3D steric and electrostatic fields generated for the molecules and selects the correlating features with biological activity. It correlates molecular properties to biological activities by a) calculating steric and electrostatic (and optionally lipophylic) potentials around the molecules, and then, b) applying the partial least squares method to the data sets.

However, in all cases the relationship between biological activities and between physicochemical properties and structure is naturally nonlinear. Recently, a conceptually different approach, the neural network methodology, has also been shown able to recognise complex relations between structural or physicochemical features of the molecules and their biological activities.

Partial Least Squares (PLS) Regression is based on factor analysis fundamentals and used, e.g. when number of variables is larger than number of compounds (i.e. over determined cases). The models obtained in PLS are still linear even in case of application of advanced variable selection methods (e.g. genetic algorithm, simulated annealing etc.).

PLS is an extension of MLR. The number of explanatory variables may run into thousands, whereas the number of compounds rarely exceeds 100. In this situation, conventional statistical methods like MLR are vulnerable to overfitting. Linear regression by partial least squares is designed to avoid that. The method reduces the explanatory data to a small number of components, or linear combinations, which are strongly correlated with the responses. The first PLS component is a trend vector of the responses in the space of the explanatory variables. The next component is the trend within a subspace orthogonal to the first; and so on. Most QSAR calculations entail enough redundancy that the major risk is that an unrecognized chance correlation misdirects experimental work. PLS is sure to filter out any chance correlations at a price of having a very small and usually acceptable risk of overlooking a correct correlation.

In other words, in order to have a robust model which generalizes, a partial least-squares method was proposed [H. Wold, In Research Papers in Statistics, 1966, Wiley, New York.]. The PLS method projects the data down to a number of principal factors and then models the factors by 1-D linear regressions. Since the dimension of each factor is one, the problems of correlation among the descriptors and limited observations are circumvented. The major restriction of the PLS method is that only linear information can be extracted from the data.

When many descriptors are used in an analysis of a large set of chemical compounds, statistical methods such as Principal Component Analysis (PCA) or PLS can establish a minimal set of important descriptors. Pharmacophore fingerprinting is an extension of the above-mentioned approach where enumerating pharmacophoric types with a set of distance ranges provides a basis set of pharmacophores. Pharmacophore screening is potentially valuable in analyzing large compound collections provided by high throughput screening and combinatorial chemistry. The pharmacophore concept is based on interactions observed in molecular recognition, such as hydrogen bonding and ionic and hydrophobic associations. A pharmacophore is defined as a set of functional group types in a specific spatial arangement that represents the common interactions between a set of ligands and a biological target.

The PCT application WO 00/25106 discloses an improved format for pharmacophore fingerprints as well as improved methods for generating and using pharmacophore fingerprints. Thereby, a pharmacophore fingerprint for a chemical compound specifies a collection of individual pharmacophores that match the structure of the compound by including distinct pharmacophores that match distinct energetically favorable conformations.

A computer implemented method for discovering structure activity relationships has been described in WO 98/07107 which utilizes weighted 2D fingerprints in conjunction with the PLS statistical methodology.

Furthermore, the European patent application EP-A-0 938 055 is directed to a method for determining relationships between the structure or properties of chemical compounds and the biological activity of those compounds.

In order to determine the activity of a chemical compound in a given biological system, it is necessary to identify the target of said chemical compound within said given biological system. Target identification is basically the identification of a particular biological component, namely a protein and its association with particular disease states or regulatory systems. Therefore, a protein identified in a search for a chemical compound (drug) that can affect a disease or its symptoms is called a target. The term “protein” refers to any chemical compound that is involved in the regulation or control of biological systems, such as enzymes, and whose function can be interfered with by a drug. Once a target has been identified the identification of a pharmaceutically active compound is desired.

Most of the published QS(P)AR valid only for limited number of compounds showing strong structural similarity to each other. Several positive Artificial Neural Network (ANN) (K. Hornik, M. Stinchcombe, H. White, Neur. Net., 1989, 5, 359-366; E. Hartman, J. D. Keeler, J. M. Kowalski, Neur. Comp., 1990, 2, 210-215; K. Hornik, M. Stinchcombe, H. White, P. Aurer, Neur. Comp., 1994, 9, 1262-1275) attempts were made to detect “drug-likeness” or predicting biological activity spectra of molecules however these experiments provided only qualitative (e.g. matching keyword) results.

Artificial Neural Networks (ANN) and NPLS (Nonlinear Partial Least Squares) can be used successfully for recognition of nonlinear correlations. The present invention discloses for the first time a descriptor selection that can be only heuristic. Furthermore, preferably automatic descriptor selection and optimization is applied within the disclosed method for generating a quantitative structure property activity relationship between the structure of chemical compound and its pharmacological and/or biological activity.

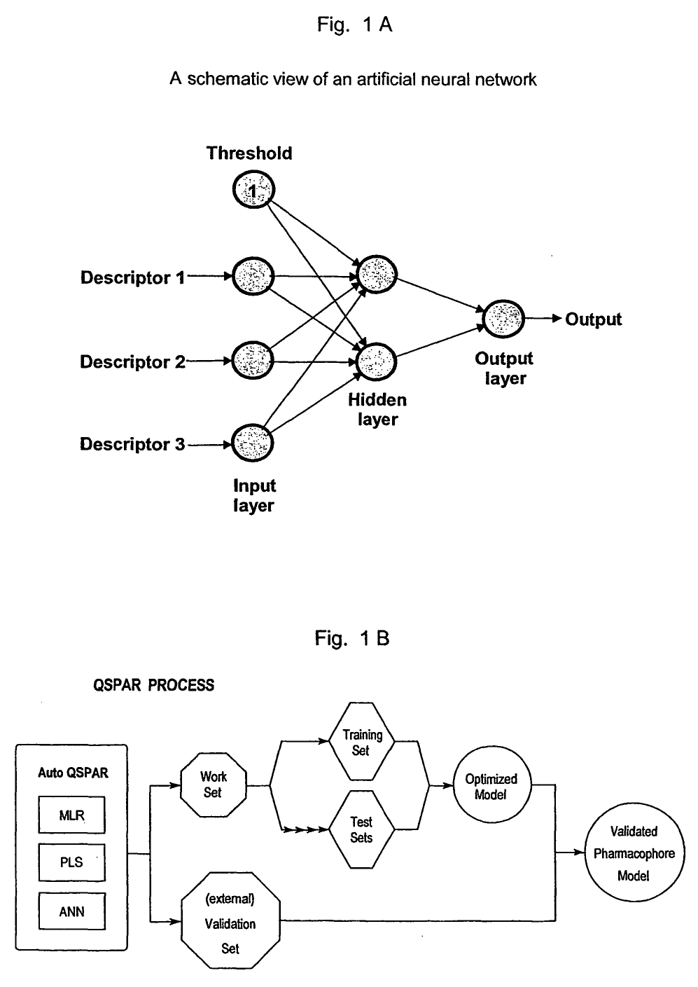

Most of the applications of neural networks in chemistry used fully connected three-layer, feed-forward computational neural networks with back-propagation training. FIG. 1A shows the schematic architecture of a typical neural network. The basic processing unit represented with a circle is the neurone, which takes one or more inputs and produces an output. Usually many inputs take values from the descriptors. These inputs are commonly called and sketched as input neurones in the input layer though in a sense that is a misnomer. No processing is done by an input neurone. They all produce an output equal to their single input. The input neurones are only a semantic construct to suggest that they pass their input toward each hidden neurone. Unlike the hypothetical input neurones, hidden layer neurones and output layer neurones are very real. Each of the hidden and output neurones accepts inputs, sums them and produces an output. At each processing neurone, every input has an associated weight that modifies the strength of each input connected to that neurone. The processing neurone simply sums all the inputs and calculates an output which should be forwarded to all other neurones in the next layer or it is displayed to the outer world. Principally, the neural networks proceed as follows:

1. each input descriptor value is multiplied by the connection weight;

2. the products are summed up at each hidden unit neurone, where a non-linear transfer function is applied; and

3. the output of each hidden unit neurone is multiplied by the connection weight, summed up at the output layer neurones and the result is interpreted.

There is a special, so-called bias neurone in the input layer. Its output is always one and its connection weights to the non-linear hidden neurones set the switching thresholds of those non-linear neurones. Neural networks are not explicitly pre-programmed for making solutions; rather they are trained through examples. During the training process values of the weights are adjusted to make the output of the network close to the expected output.

In respect to the performance of a network, two mathematical issues need to be considered: the representation power of the network, and the training algorithm. The first one relates to the ability of a neural network to represent a desired function. Since a neural network is built up from a set of standard functions, it can only approximate the desired function. Therefore, even in the case of an optimal set of weights, the error of approximation can never reach the value of zero.

Fully connected, three-layer, feed-forward computational neural networks with non-linear transfer function in the hidden layer have provided excellent performances in many applications of fitting and reproducing almost any non-linear hypersurface, due to the universal approximation theorem. The theorem says that these types of networks can approximate any functions with finitely many discontinuities to arbitrary precision. As discussed above, most of the QSAR methods are based on a multiple linear regression or partial least squares analysis. Therefore, these approaches can only capture linear relationships between molecular characteristics and functional properties. In contrast, neural networks can recognise highly non-linear relationships between different features.

Object of the present invention is to still improve the known methods for generating structure activity relationships.

This object is solved by the disclosure of the independent claims. Further advantageous features, aspects and details of the invention are evident from the dependent claims, the description, the examples and the figures of the present application.

### DESCRIPTION OF THE INVENTION

The present invention is directed to a method for generating a quantitative structure property activity relationship between the structure of chemical compounds and their pharmacological/biological activity, said method comprising:

a) establishing at least one database containing molecular descriptors especially 2D and/or 3D biological/physical/chemical data;

b) providing at least a model for generating a quantitative structure property activity relationship;

c) selecting significant descriptors according to their influence to said structure property activity relationship;

d) verifying said model by the use of at least one quality parameter; and

e) repeating steps b, c, and d until said quality parameter reaches a predetermined value.

In order to overcome the drawbacks of the methods of the state of the art, especially the drawback that only linear relationships between molecular and/or structural parameters and biological activity can be calculated, the present invention preferably uses neural networks. This inherent feature of non-linearity makes neural networks particularly well suitable to treatments of generally non-linear structure activity relationships. Thus, the inventive QSPAR method disclosed herein preferably uses neural networks for the generation of a quantitative structure property activity relationship between the structure of chemical compounds and their pharmacological and biological activity.

A neural network learns by passing through the data repeatedly and adjusting its connection weights to minimise the error, e.g. the difference between predicted versus actual biological activities. The method of weight adjustment is known as the training algorithm. There are now various algorithms in use, of them the most common one is the back propagation of errors. Although it is not the fastest method in terms of training, it has a very useful convergence property. Namely, if the number of input descriptors are greater than the number of hidden neurones—a carefully selected network architecture usually has less hidden neurones than input descriptors—, convergence of the network to a global optimum is always ensured by back propagation.

Some important practical features of neural networks should still be considered.

They can learn everything, apparently, without any limitation, and this ability might be a source of overfitting the data. To avoid this, it is preferred that, like in other QSAR methods, the experimental error of measured data, which should be predicted or represented by the neural network calculations, is defined.

A validation process preferably evaluates the competence of any QSPAR model.

Preferably, the known cases are divided into two disjoint sets. One is the training set; the other is the validation set. Most preferably, the validation set is an external validation set. The term “external” refers to the fact that the data of this kind of the validation set is not used in the process of QSPAR model generation. It is used only once after the model has been generated to check the model predictive ability on data never seen before. This kind of validation is called sometimes as “true” validation as well. In many respects, a proper validation process is more important than a proper training. Therefore, the method for generating a quantitative structure property activity relationship disclosed in the present invention preferably splits the used database into a work set and an external validation set. The work set is preferably further divided into at least one training set and at least one so called “monitoring” test set. Preferably, the QSPAR method in the present invention uses between 10 and 100 training sets-monitoring test sets and more preferably around 50 to 100 training set-monitoring test set divisions parallely. To use such an ensemble of training set-monitoring set divisions of the work, set data has the advantage that the obtained QSPAR model reflects true relationships (if any) between the X and Y variables since it cannot learn any work set subdivision peculiarities, because these are averaged out over the ensemble of several different subdivisions. More than 99% of the literature examples of QSAR use only a single work set-validation set without an external validation. This inadequacy in the traditional approach is one of the main reasons why QSAR has not became an industry standard. FIG. 18 shows a schematic QSPAR process.

The QSPAR method disclosed in the present invention is suitable for the recognition of existing relationship between data even in case the other procedures fail (e.g. underdetermined cases).

The general form of a QSAR relationship is: f(bᵢ . . . zᵢ)=Aᵢ

The biological activity of the “i” molecule (Aᵢ) can be approximated from a (linear or preferably non-linear) function of a significant set of the corresponding theoretically or experimentally determined molecular descriptors (bᵢ,zᵢ).

The scientific literature refers successful applications of many different kind of descriptors for QSAR studies (cf. Table 1). The experimental determination of physico-chemical properties (e.g. logP, pKa, dipole moment etc.) for thousands of compounds is a time consuming and expensive procedure. Obtaining calculated descriptors is cheaper, faster and their reliability is comparable to experimental biological data.

The 3D low energy structural data of conformers of compounds can be obtained from quantum chemical or semi-empirical calculations. The exact calculation of data for only one hundred molecules in this way would need unbelievably long computer time or extremely high performance. Therefore many methods applying simple, standardized transformation of 2D structures into 3D using experimental datasheets and/or theoretically calculated data (e.g. the popular Concord (Tripos) or Corina (Gasteiger) etc.) have been developed. A preferred embodiment of the present invention also converts 2D biological and/or physical and/or chemical data into 3D data.

These 3D structures could be far from the energy minimized conformations and representing only one conformation from the possible dozen but are still applicable for comparison of compounds because all of the structures derived by the same standard rules. Many of the descriptors listed below in Table 1 can be calculated with satisfactory precision from even 2D (or connectivity) data.

QSAR correlations of the model fitting can be published in the literature even from 0.4 value of correlation coefficient between the experimental and calculated figures.

These correlations are mostly chance correlations which may be acceptable to show trends only but they are far from those that yield reliable predictions. But if the truly, i.e. externally cross validated Q² of a model predictions has 0.4 or higher value on a properly defined external validation set portion, e.g. higher than 10 percent, of the available experimental data, there is only a very low probability that such externally validated correlation is only by chance.

Thousands of chemical structure descriptors are calculated internally in the 3DNET program. These are listed in Table 1. However the automatic QSPAR model generation of the present invention can use experimental data sets or calculated and tabulated descriptor sets from external sources and from databases as well.

TABLE 1
Descriptors calculated by 3DNET

| | No. of available | |
|---|---|---|
| Descriptors | descriptors^{a} | Reference |
| Molecular mass^{b} | 1 | |
| Molecular volume, solvent extended volume^{b} | 2 | [1, 4, 18] |
| Molecular surface, solvent accessible surface, solvent | 3 | [1, 3, 4] |
| extended surface^{b} | | |
| Globularity^{b} | 1 | [2] |
| WHIM descriptors of atomic mass, position, electronegativity, | 7 × 7 = 49 | [13] |
| localised charge, atomic polarizability | | |
| contribution, atomic electro topological index, pi | | |
| functionality; moments and T A V K combinations were | | |
| used^{b} | | |
| Polarizability^{b} | 1 | [5, 6] |
| Dipole moment^{b} | 1 | [7] |
| Hildebrand solubility parameter^{b} | 1 | [12] |
| LogP^{b} | 1 | [8] |
| Unsaturation number^{b} | 1 | |
| Degree of chemical bond rotational freedom^{b} | 1 | [9] |
| Wiener lndex^{b} | 1 | [14] |
| Randics Index^{b} | 1 | [15] |
| HDSA1, HDSA2, HASA1, HASA2 hydrogen bond (HB) | 4 | [16] |
| descriptors^{b} | | |
| Gravitational index^{b} | 1 | [16] |
| Topological electronic index^{b} | 1 | [16] |
| QN, QO, QNO, QTOT Bodor charge descriptors for logP^{b} | 4 | [17] |
| Min., max. and average of electrostatic potential (ESP) on | 3 | [5] |
| the vdw surface^{b} | | |
| Histogram of ESP distribution on the vdw surface (8 cells)^{b} | 8 | [5] |
| Min., max. and average of molecular lipophylicity potential | 3 | [5] |
| (MLP) on the vdw surface^{b} | | |
| Histogram of MLP distribution on the vdw surface (8 cells)^{b} | 8 | [5] |
| Number of specified atom types^{b} | 35 | [a] |
| Min., max. and average of localised charge on any atom | 95 | [5, 7] |
| type^{b} | | |
| Electrostatic HB basicity and acidity, max. plus summed | 4 | [11] |
| values^{b} | | |
| HOMO, LUMO (AM1) | 2 | [11] |
| Auto correlation functions of atomic mass, position, | (35 + 8) × 6 = 258 | [8] |
| electronegativity, localised charge, atomic polarizability | | |
| contribution, atomic electro topological index, pi | | |
| functionality, logP contrubution and of any atom type from 1 | | |
| angstrom to 7 angstroms in 6 steps^{b} | | |
| Pair correlation functions of atomic mass, position, | 903 × 6 = 5418 | [8] |
| electronegativity, localised charge, atomic polarizability | | |
| contribution, atomic electro topological index, pi | | |
| functionality, logP contribution and of any atom type from 1 | | |
| angstrom to 7 angstroms in 6 steps^{b} | | |
| 3D MoRSE codes of atomic mass, position, | 903 × 16 = 14440 | [10] |
| electronegativity, localised charge, atomic polarizability | | |
| contribution, atomic electro topological index, pi | | |
| functionality, logP contribution and of any atom type from 0 | | |
| to 8 angstrom⁻¹ in 16 steps | | |

^{a}3DNET manages 35 atom types. The number of calculated descriptors are shown accordingly.
^{b}Descriptor investigated in this work. 11 atom types were used: H (lypophylic, HB don.), HB donor (O, N), HB acceptor (O, N), C (sp³, sp²), N (sp³, sp²), O (sp3, sp2), halogens.
[1] M. L. Connolly, J. Am. Chem. Soc., 1985, 107, 1118-1124
[2] A. Y. Meyer, J. Chem. Soc. Rev., 1986, 15, 449-474
[3] K. Iwase, K. Komatau, S. Hirono, S. Nakagawa, I. Moriguchi, Chem. Pharm. Bull., 1985, 33, 2114-2121
[4] J. De Bruijn, J. Hermens, J. Quant Struct-Act. Relat., 1990, 9, 11-21
[5] A. Breindl, B. Beck, T. Clark, R. C. Glen, J. Mol. Model., 1997, 3, 142-155
[6] K. J. Miller, J. Am. Chem. Soc., 1990, 112, 8533-8542
[7] W. J. Mortier, K. van Genechten, J. Gasteiger, J. Am. Chem. Soc., 1985, 107, 829
[8] P. Broto, G. Moreau, C. Vandycke, Eur. J. Med. Chem., 1984, 19, 71-78
[9] P. R. Andrews, D. J. Craik, J. L. Martin, J. Med. Chem., 1984, 27, 1648-1657
[10] J. Schuur, P. Selzer, J. Gasteiger, J. Chem. Inf. Comput. Sci., 1996, 36, 334-344
[11] T. D. Cronce, G. R. Famini, J. A. De Soto, L. Y. Wilson, J. Chem. Soc. Perkin Trans. 2., 1998, 2, 1293-1301
[12] R. F. Fedors, D. V. Van Krevelen, P. J. Hoftyzer, In CRC Handbook of Solubility Parameters and Other Cohesion Parameters, 1986, CRC Press, New York
[13] R. Todeschini, P. Grammatica, Quant. Struct.-Act. Relat. 1997, 16, 120-125
[14] H. Wiener, J. Am. Chem. Soc., 1947, 69, 2636-2641
[15] M. Randic, J. Am. Chem. Soc., 1975, 97, 6609-6615
[16] A. R. Katritzky, V. S. Lobanov, M. Karelson, J. Chem. Inf. Comput. Sci., 1998, 38, 28-41
[17] N. Bodor, M. J. Huang, A. Harget, J. Mol. Struct. (Theochem), 1994, 309, 259-266
[18] N. Bodor, P. Buchwald, J. Phys, Chem., 1997, 101, 3404-3412

One fundamental basis of the present invention is the recognition that measured or automatically calculated biological and/or physico-chemical and/or structural data are linked to the corresponding molecular structures. If they are collected in a standardized database format, that will then permit the automatic and fast development of optimal quantitative structure-(property)-activity relationships (QS(P)AR). The term “optimal” refers to the maximum validated prediction power that can be obtained from the available data. This automatic QS(P)AR analysis can preferably be performed by the simultaneous, automatic application of PLS, MLR and ANN algorithms to achieve an optimal quality parameter.

There is no optimal mathematical model for everything when one deals with noisy experimental data. For every QS(P)AR method in the literature there are examples to show the superiority of a given method and to show the inferiority of the given method as compared with other algorithms. These literature examples use different data sets to verify their contradictory conclusions. However, this proves only that different data may need different methods for good predictive analysis. That is why the present invention preferably uses three basic mathematical frameworks for QS(P)AR data analysis. MLR is good for highly linear relationships among few variables and low noise, good quality experimental data, PLS is superior for mainly linear trends among numerous variables and moderately noisy experimental data, and ANN performs well even for very noisy experimental data or generally better or at its best when clearly nonlinear relationships exist for fairly noisy experimental figures. All of these analyses can be performed automatically and the preferable method can be selected by the user by comparing the external validation set prediction quality figures.

Therefore, another preferred aspect of the present invention is directed to a simultaneous, automatic application of PLS, MLR and/or ANN algorithms within the disclosed method for generating a quantitative structure property activity relationship. The used algorithms may comprise sequential and genetic algorithms wherein the genetic algorithms preferably represent a double roulette wheel algorithm.

Furthermore, the QSPAR method of the present invention incorporates the use of at least one quality parameter. Said quality parameter is preferably a cross-validated correlation coefficient (Q²) or a standard error of prediction (SEP) factor or a Spearman's Rank Comparison Coefficient or a TOP25% hit factor or a BOTTOM25% hit factor. The Q² quality parameter has the range from minus infinity to 1 (best possible). The SEP value has the range from zero (best possible) to plus infinity. The Spearman's rank correlation coefficient has the range from −1 to +1 (best possible). The TOP25% hit factor shows what percent of the molecules which are in the set of the altogether one quarter of the molecules with the highest experimental figures are really predicted to be in that set when you select them according to predictions. This quality parameter spans from 0 to 100 (best possible). Similarly, the BOTTOM25% hit factor, which shows the quality of predictions in the low range of the experimental figures, is between 0 and 100 (best possible).

All of the above listed quality parameters are indicators for the “goodness of estimation”. They show and quantify predictive ability of the model instead of fitting capability of it. Therefore they are more appropriate for developing models for predictions than the r² “correlation coefficient” of the model fitting, which was previously widely used in the generation of QSPAR models.

Within the present invention an extended formula for calculation of Q² is applied:

Q²=1−(PRESS/MEANPRESS)=1−[Σ(calc−exp)²/ΣE(meanexp−exp)²]

calc=calculated value

exp=experimental value

meanexp=mean of the experimental values

PRESS=Predictive Error Sum of Squares

MEANPRESS=mean of the Predictive Error Sum of Squares

The classic expression for SEP is:

SEP=\sqrt{(press)/(m−n)}={square root over ((Σ(calc−exp)²)/(m−n))}

m=number of molecules

n=number of parameters

The above expression is valid only if: m>n

Within the present invention an extended definition for SEP which is valid for any case is applied:

SEP=λ·\sqrt{(PRESS)}

λ={square root over ((1/(m−n));)} in the case m>n

λ={square root over ((2−(1/(2+n−m));)} in the case m<n

The QSPAR method of the present invention preferably calculates the molecular descriptors for each molecule for the model generation and selects the significant descriptors by ranking them according to the ratio of the normalized contribution (e.g. %) of the descriptors to the output. According to a further preferred aspect of the present invention in the generation of the optimal QSPAR model a method for the calculation of the importance of the descriptors is used. Thus, a further preferred aspect of the present invention is related to said automatic selection of significant descriptors. In order to speed up the disclosed method the selection of significant descriptors may also be user defined.

The importance (=“significance”) of a given descriptor is preferably automatically calculated like the absolute value of the partial numeric derivative of the outcomes by the explanatory variable. The importance (=“significance”) of the descriptors is not only ranked but preferably also normalized by taking the most important descriptor as 100%.

According to a further preferred aspect of the present invention in the generation of the optimal QSPAR model a stepwise, i.e. several parallel monitoring cross validations during the model optimization is used. After that an external, statistically not self-referencing final cross-validation is preferably performed.

When the validated quality parameters, e.g. Q² of the optimal QSPAR model are satisfactory, e.g. Q²>0.4, the model can be used for the reliable prediction of biological activity and/or biological properties of existing or virtual libraries of molecules. This way potential drug molecules can be selected from large databases where the selection is based upon all structural information given.

Furthermore, the software preferably uses during model building all existing data stored in the database and preferably calculates the missing computed descriptors and writes them back into the database. In this way it is capable to recognize inner relationships among measured biological data as well.

The QSPAR models (debug files, datasets in the model, predicted values, validation data etc.), are preferably stored in a separate database connectable to the standard database.

The automatic QSPAR models are preferably validated by the recently used most accepted cross-validation methods (split-half, leave-n-out, leave-one-out or split n parts) at a user defined level. The method preferably uses a novel iterative validation as follows: the data are automatically, either randomly split before the model building into work set and external validation sets, or this selection is made in a way that yields maximally diverse work set and external validation set in the Euclidean space of the normalized descriptors. Then the work set (used for descriptor selection and model building) is further randomly split into a parallel ensemble of training sets and monitoring test sets where each member of monitoring validation ensemble is generated according to the user selected framework of the split-half, leave-n-out, leave-one-out or split n parts algorithms.

In a preferred sequential variable selection method in this invention the models are generated successively. The selection of the significant descriptors is preferably performed by a method comprising the following steps:

(A) The user selected quality figure of prediction is calculated for each member of the monitoring validation ensemble. Their average quality figure is calculated too.

(B) The significance of descriptors are calculated for each member of the monitoring validation ensemble.

(C) The significance of the descriptors are weight averaged over the ensemble using the selected quality figure of predictions of the members of the monitoring validation ensemble as the weights.

(D) The descriptors are ranked according to their ensemble averaged importance.

(E) Descriptors with low importance are sequentially removed, starting with the lowest one and so on, and the monitoring cross validation ensemble averaged quality figure is calculated for the new model. If the ensemble average quality figure improves, the just removed descriptor is left out permanently from the model and this calculation is repeated from point (B) until no further improvements can be obtained.

(F) From this point the until now permanently removed descriptors are systematically reinserted into the model one-by-one and the ensemble averaged quality figure is calculated for each trial. When the ensemble averaged quality figure improves the just now reinserted descriptor becomes a part of the model again. This process is repeated until no further improvement of the averaged quality figure can be obtained.

(G) The whole process above is repeated from step (A) until not a single or not any pair of the model's descriptors can be removed or not a single one of the left out descriptors can be reinserted into the model without deteriorating the monitoring ensemble averaged quality figure of the predictions.

The novel and mathematically very effective key step in the above listed process is the selection of the descriptors for removal according to their calculated significance. Since all, i.e. MLR, PLS and ANN methods are invented to be very good data fitters they use each of their available descriptors well in the least squares optimized fitting equation and only a few percent of the descriptors are removable from the obtained although overfitted models, even when one uses a lot of descriptors. Purely random selection has to make a lot of trials to locate those few removable descriptors. In the present invention even when the model contains 2000 descriptors usually the first 5 trials will certainly find a removable descriptor. This order of magnitude hit success advantage, when compared with a random descriptor selection, is further amplified because the process can be repeated for thousand times. When the model stabilizes it contains only 10 to 50 descriptors and the systematic one-by-one checking of each one and of each pair is very fast.

A GA descriptor selection is a further preferred method for the descriptor selection.

Preferably a GA descriptor selection with the double roulette-wheel selection is embodied in a classical genetic algorithm framework. A member of the QSPAR model generation is characterised with a chromosome. This is a series of 0-s and 1-s, where 1 denotes that a given descriptor is used in that QSPAR model. Each QSPAR model has the selected quality figure as the measure of its fitness or vitality. After the fitness based roulette-wheel driven crossover of the chromosomes according to the classical genetic algorithms, bit mutation is applied. In the classical method it uses a 50%-50% chance to set a randomly selected bit to 0 or to 1. In the present invention the importance of the descriptors over the monitoring cross validation ensemble is calculated and the obtained significance values are preferably used to favour the possibility of choosing the significant descriptors during bit mutation. The present invention preferably applies a second roulette-wheel algorithm where the descriptors proven to be significant in one or more models have a larger section of arc at the perimeter of the selection wheel belonging to their 1 values than those descriptor that are not significant. In this way if a descriptor turns to be a good predictor in one model it will quickly spread over the population making the bit mutation scheme more effective than the blind selection.

Randomly fluctuating and low Q² and high SEP values indicate that even the optimal model obtained from the existing dataset cannot be used for prediction, because of not enough or not sufficiently good quality of data.

Non self referencing, iterative validation in this context means that a validation set can be used for validation only once in the same model building process and its molecules are never “seen” by the model before the validation.

The optimal pharmacophore model, generated by the QSPAR method of the present invention, preferably specifies value intervals (ranges) for the descriptors needed for the description of the relationship. Therefore the “pharmacophore model” can be fitted on diverse molecular structure sets as well. The significant (important) descriptors, if any, and the correlation function between these descriptors and between the biological activity can be found automatically. Then, the statistical measures of the best predictive correlation in the used dataset have been clear-cut. The basic assumption however is that similar molecules tend to have similar biological activity. The key point here is that the method of the present invention can find similarity patterns in the space of calculated abstract or measured experimental descriptors for largely different chemical structures. In other words the scope of the term “similarity” is expanded to the realm of very different chemical structures. Thus, another aspect of the present invention is related to an embodiment of the disclosed QSPAR method for generating a quantitative structure property activity relationship of chemical compounds with no close relation or no relation at all in chemical structure.

Furthermore, the disclosed QSPAR method indicates automatically whether an optimal model could be obtained from the existing dataset or more data are necessary. Another advantageous aspect of the present invention is that the obtained QSPAR data can after experimental verification added to said database and can be used for obtaining improved quantitative structure property activity relationships by repeating the inventive QSPAR method.

Whenever necessary, user defined intervention may be possible in order to speed up the QSPAR method disclosed herein.

In relation to the above-mentioned disclosures the present invention is directed to a system for generating a quantitative structure property activity relationship between the structure of chemical compounds and their pharmacological activity, said system comprising:

a) at least one database unit containing molecular descriptors especially 2D and/or 3D biological/physical/chemical data;

b) selection unit for selecting significant descriptors according to their influence to said structure property activity relationship;

c) model unit containing at least a model for generating a quantitative structure property activity relationship;

d) quality unit containing at least one quality parameter for measuring the goodness of the generated structure property activity relationship; and

e) optimization unit for controlling the selection unit and the model unit so that said quality parameter reaches a predetermined value.

In a preferred embodiment said system further comprises a general menu driven software shell for the connection of the modules and for providing the possibility of user interventions.

2D pharmacological and/or chemical data used by said system are preferably converted to 3D data. The models for generating a quantitative structure property activity relationship within said system preferably comprise PLS, MLR and/or ANN algorithms and at least one validation algorithm. More preferably said algorithms comprise sequential and/or genetic algorithms and most preferably the genetic algorithm represents a double roulette wheel algorithm.

The database of the system preferably comprises a work set and a validation set wherein the work set is preferably further divided into at least one training set and at least one test set.

The system comprises at least one quality parameter. Said quality parameter may be the Q² cross-validated correlation coefficient or the standard error of prediction (SEP) factor or the Spearman's rank correlation or the TOP25% or the BOTTOM25% hit ratios.

In one preferred embodiment the system may comprise a menu driven software shell, a unified standard formatted database containing pharmacological and chemical data (2D and 3D) and a unified standard database containing models and their calculated or measured descriptors and all of their parameters. In addition thereto, subroutines for descriptor calculations and writing back calculated data into the database(s) are preferably provided together with scoring functions for ranking the molecular descriptors and at least one sequential algorithm for the selection of the significant descriptors. Preferably, genetic algorithms like double roulette wheel algorithms are used for the selection of significant descriptors. Furthermore, QSPAR algorithms like PLS, MLR, and ANN are provided together with validation algorithms (Leave-one-out, leave-n-out, split-half and split n parts).

The required time of the calculation, when starting from 1000 descriptors and searching the most important 100 among them by systematically checking the 6.38×10¹³⁹ possible combinations, would take about 10³⁸ years if one could use a million teraflop supercomputer. That time is about 10²⁸ times longer than the age of the universe and a million teraflop computer has not yet been built. Therefore, the present invention preferably uses a scoring function that quantifies the importance of the descriptors in the predictions. The application of the scoring function decreases dramatically the required time for generating said quantitative structure property activity relationships.

In a further aspect the present invention is related to a computer program product stored on a computer readable medium for performing the method of anyone of claims 1-14 when said program is run on a computer.

Flow Diagram 1

In the following an example for a stepwise schematic structure of a preferred example of the inventive QSPAR method is given (cf. FIG. 1B). Said method may be speeded up at any step of the process by user intervention. User interventions at reliable positions of the process are indicated by “#”.

Step 1: Establishment of the Unified Database.

The data should be validated with suitable standards and filled into the database. The structural data are converted (#) from 2D into 3D.

Step 2: The QSPAR method uses the data from the unified database. A program checks the data fields, (acceptable data format, validates value ranges, etc.) then calculates all of the marked (#) descriptors and stores them in the database.

Step 3: A program splits the database content into two parts: work set and validation set (#). The work set is split again (#) into training sets and test sets. The split ratio and method can be adjusted by the user in each case.

Step 4: The user selects (#) from the three basic QSPAR methods at least one method for the model generation.

Step 5: Then the user selects (#) between the sequential and the genetic algorithm descriptor selection methods to be used for the method optimization.

The sequential algorithm selection of descriptors is based on the stepwise iterative training-reselection of the significant descriptors described previously. This method will certainly find an optimal QSPAR model fairly quickly. There is however a non neglectable possibility that the so found model is only locally optimal.

The genetic algorithm selection uses the double roulette wheel method.

The system (or user (#)) selects a subset of descriptors, checks the ranks of the descriptors and then tries a random replace of the descriptors with others while it is monitoring the changes in the importance (“significance”) of the corresponding descriptor in the model. It automatically stores the higher rank combinations and recombining the “most vital species” and tries to develop an optimal model. This way each descriptor can be taken into account in any combination therefore. This method is likely to find the globally optimal QSPAR model using the advantage of the double roulette-wheel selection based upon the novel calculation scheme for the importance of the descriptors. It may need more time then the sequential selection algorithm to be practically sure that the globally optimal QSPAR model has been obtained.

Step 6: External, i.e. True Validation

The models obtained by either algorithm is validated by the external validation set data. The validation process is fully automatic, it provides the most reliable results without user intervention. Of course there is a feature for the user to validate the model not only with random or uniformly selected external validation set but also with user (#) selected data. In each cases the external validation set data is not used during the model optimization process.

Step 7: Use of the Method for Model Optimization

The new data generated by assays and/or experiments can be attached to the database first as validation set. The program predicts the biological and/or physical-chemical data and compares the calculated values with the measured ones. The correlation data are stored and the new data merged into the model dataset and being reanalyzed (steps 1 to 7). The new model containing the modified correlation parameters and descriptors is stored into the model database.

Step 8: Use of the Method for Lead Selection (Prediction)

The virtual library data (from any source) should be filled into the unified database in 2D and/or 3D structural format. Then the user may select an acceptable model (2D or 3D) from the model database. The QSPAR method predicts the desired values for the library and stores the calculated values in the database.

Step 9: Use of the method for validation of datasets

Since the method should find any kind of correlation automatically between descriptors and the biological activity or physical-chemical data, it is suitable for validation of datasets also. It is able to identify datasets with high experimental error automatically and quickly during the high throughout screening process.

For instance, HPLC retention data obtained from a standardized experiment series with structural data (descriptors) can be used for the validation of HPLC data of new compounds under the same circumstances which is useful for structure validation or for the experiment validation.

Reasonable amount of biological physico-chemical data with adequate quality analyzed by the system should give an optimal model by the said method with convergent Q², SEP, rank correlation, TOP25% or BOTTOM25% values. Random changing or notoriously low figures for this values indicate low quality or not sufficient data for model building.

### EXAMPLES

In the following preferred examples of the inventive method/system are explained in greater detail. In this examples 3D structures for all of the compounds, obtained previously with the Concord module of Tripos SYBYL program system [CONCORD 6.0, 1992, TRIPOS Associates Inc., St. Louis, Mo.] were used. The 2D and 3D chemical structures along with the activity data were stored in MDL ISISBASE format [ISIS/Base, Ver. 2.2.1, 1999, MDL Information Systems Inc. San Leandro Calif.]. In every model optimization the program was allowed to use 3D holistic descriptors. A large pool of descriptors were calculated for each molecule, including 1D, 2D and holistic 3D descriptors. These descriptors are listed in Table 1. In the examples 11 atom types were taken into consideration and were computed by the auto- and pair correlation functions in 6 equidistant steps from 1 angstrom to 7 angstroms.

Model Building, Descriptor Selection and Validation

MLR, PLS and ANN algorithms are used in the automatic QSPAR system along with automatic cross-validation procedures. All of the models are developed using a large ensemble of cross-validation sets for monitoring descriptor selection and using true validation sets (sets that are not used in the model building process) to estimate the predictive ability of the obtained models. In the following examples split-half cross-validations and leave-N-out cross-validations were used during the variable sections. The sequential model buildings were stopped when the removal of any descriptors from the model decreased the average Q² on the monitoring set-training set ensembles. The predictive ability of the models is finally assessed by the Q² value of predictions on the validation sets. For each set of molecules a work set and a validation set were generated randomly. The validation sets were put aside and were not used during the model optimization. For the MLR and for the PLS models the work sets were further divided into equal parts randomly. This was repeated 32 times. For the ANN models 80% of the work sets was randomly selected for training the remaining 20% for monitoring. This was repeated 8 times. The average of the cross-validated Q² values was maximized over these cross validation ensembles. The optimal models were finally trained with the whole working set and were applied to predict the corresponding activity values of the validation set molecules.

The importance of the descriptors is assessed by evaluating the sensitivity of the results of the given model for the given descriptor. In MLR and in PLS calculations the absolute values of the descriptors coefficients are used to quickly quantify the importance of the descriptors in the model. In the ANN calculations a surplus input layer is added and the descriptor values are pushed to the zero stepwise. During this step the back-propagation algorithm tries to decrease the growing error of the calculated outcome by increasing the network weight of those inputs that are relevant for the calculation of that outcome. The extra network weight for each input is sorted and the largest one was taken as 100% of relative importance on a linear scale. All descriptor selections are controlled and checked by the applied cross-validation method. The model is built and the relative importance of the descriptors is calculated. The descriptor with the lowest importance is removed and the model is rebuilt and validated for each member of the cross validation ensemble. If the average Q² of the cross validation ensemble increases the model is rebuilt again and the process is repeated with the removal of the least important descriptor again. If the removal of a descriptor did not improve the average Q², the descriptor is put back into the model and the next lowest important descriptor is removed and Q² is checked again on the whole ensemble. This systematic descriptor removal and Q² trial is stopped when the removal of any descriptor from the model decreases the Q² value. After this, the predictions of the model for the true validation set molecules were evaluated.

### Example 1

### Tumor Dihydrofolate Reductase (DHR) Inhibitors

Analysis of the classical dihydrofolate-reductase inhibitors dataset studied by Hansch et al. (MLR, PLS, ANN models). Hansch utilized his QSAR approach in his analysis of 256 4,6-diamino-1,2-dihydro-2,3-dimethyl-1-(X-phenyl)-s-triazines which were tested against tumor dihydrofolate reductase [J. Schuur, P. Seizer, J. Gasteiger, J. Chem. Inf. Comput Sci., 1996, 36, 334-344]. This data became a test set for several QSAR study [T. A. Andrea, H. Kalayeh, J. Med. Chem., 1991, 34, 2824-2836; Sung-Sau So, W. G. Richards, J. Med. Chem., 1992, 35, 3201-3207; R. D. King, S. Muggleton, R. A. Lewis, M. J. E. Sternberg, Proc. Natl. Acad. Sci. USA, 1992, 89, 11322-11326]. The log(1/IC₅₀)=pIC₅₀ values were reproduced or predicted.

It is interesting to note that the original article contains two pairs of identical compounds among the 256 (namely compounds 112, 202 and compounds 186, 188). I.e., different IC₅₀ values for the same structures are listed. None of the following publications mentioned this, but used and printed the original data. In each identical pair the higher activity compounds were excluded from the studies disclosed herein. Therefore, calculations were performed with 254 DHR inhibitors only. 240 molecules were selected randomly for the work set and 14 molecules for the validation set. The validation parameters of the optimized models are shown in Table 2. For the sake of comparison a leave-one-out cross validation was made with the best ANN model. Even the leave-one-out cross-validated Q²=0.855 value compared well with the best R² values of fitting found in the literature with ANN, MLR and PLS models [T. A. Andrea, H. Kalayeh, J. Med. Chem., 1991, 34, 2824-2836], where the corresponding figures were 0.850, 0.494 and 0.773, respectively. The R² of fitting of the cross-validated NN model used within the present invention was 0.910 for these compounds.

TABLE 2
QSAR model data for DHR inhibitors

| | Model | | |
|---|---|---|---|
| | MLR | PLS | NN |
| Maximum average | 0.499 | 0.503 | 0.712 |
| Q² of monitoring | (average of 32 | (average of 32 | (average of 8 |
| validations | values) | values) | values) |
| Q² of final | 0.553 | 0.648 | 0.661 |
| validation | | | |
| Model parameters | 23 parameters | 15 parameters, | 5 hidden neurons, |
| | | 14 components | 140 parameters, |
| | | | ρ = 1.71 (at 240 |
| | | | compounds) |

| | |
|---|---|
| Common | Volume, degree of rotational freedom, 1^{st} |
| descriptors that | lipophylicity moment, Wiener index, |
| appear in at least 2 | electronegativity-vdw volume pair correlation, |
| optimized models | vdw volume - pi functionality pair correlation, |
| | vdw volume - electrotopological index pair |
| | correlation |

Demonstration of a Single External Validation of DHR Pharmacophore Models:

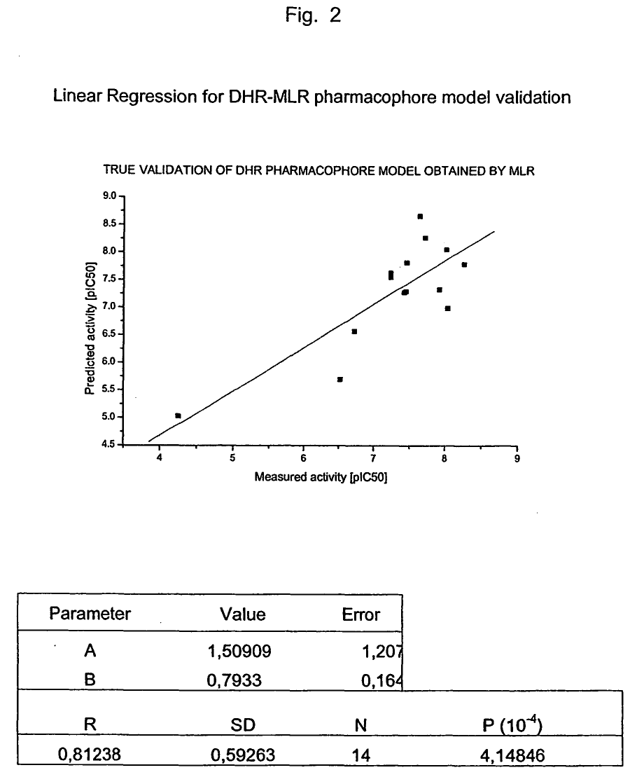

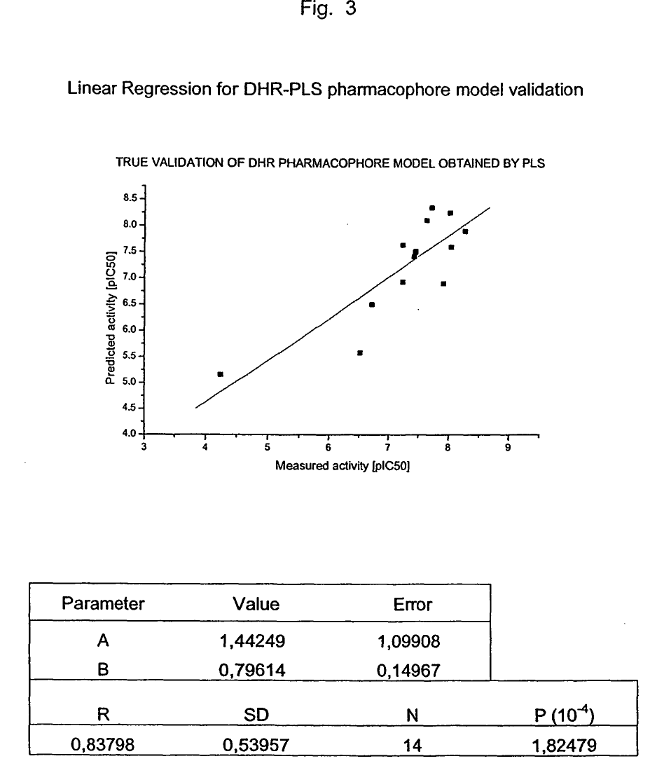

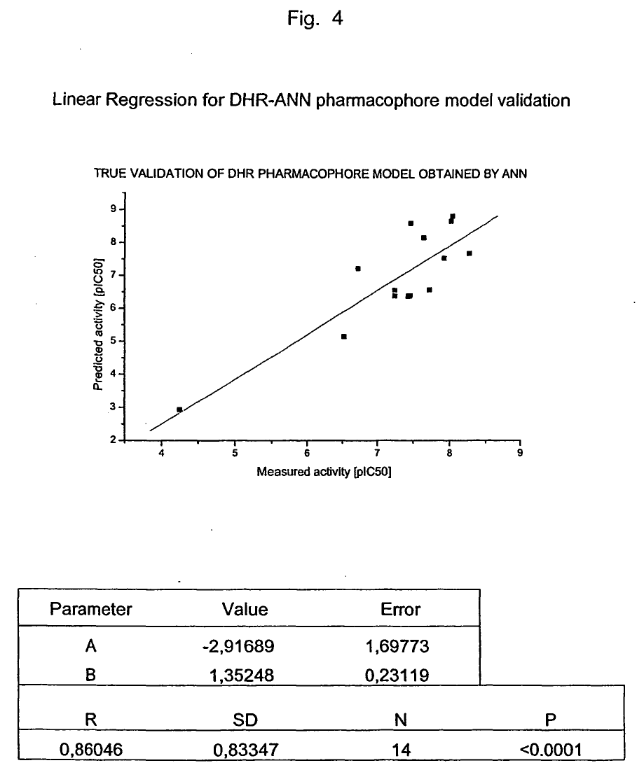

Building of the model was optimized via series of training set-test set selections, training and validation cycles. The maximum averages of Q² values are given in Table 2. Visualized in FIGS. 2, 3, and 4 are the validation data of the final model obtained by MLR, PLS, and ANN respectively, with a single external validation set which was excluded from the model building.

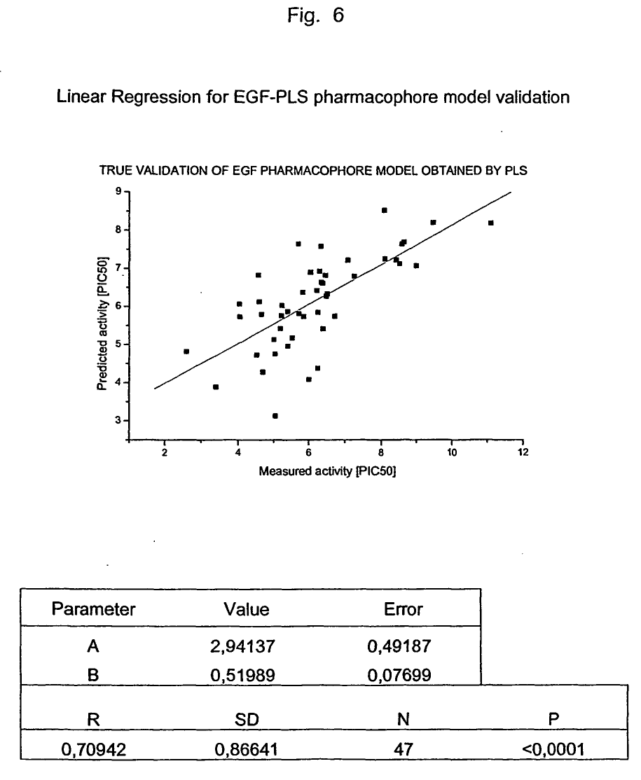

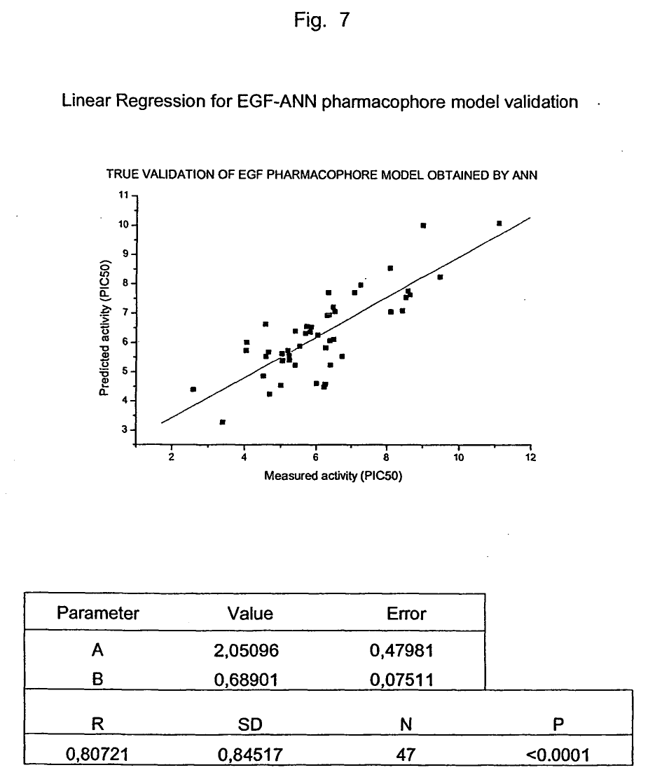

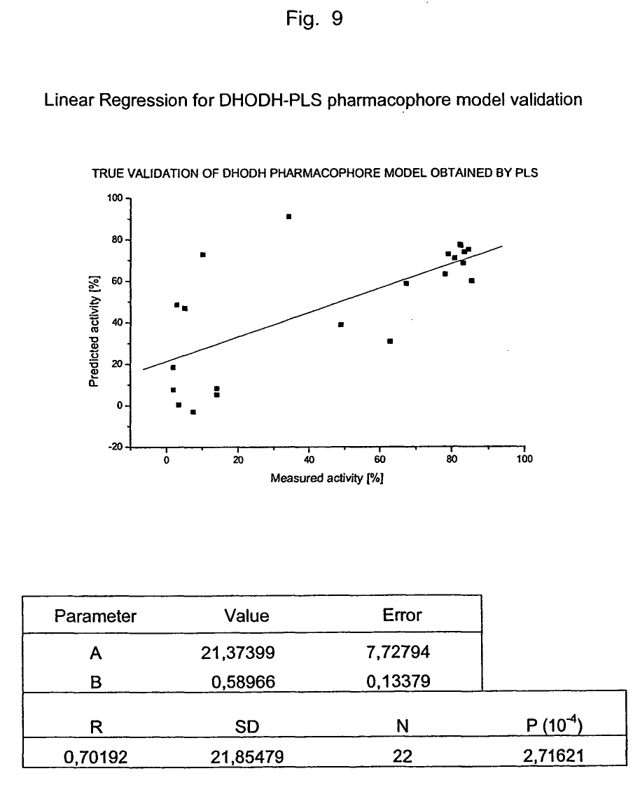

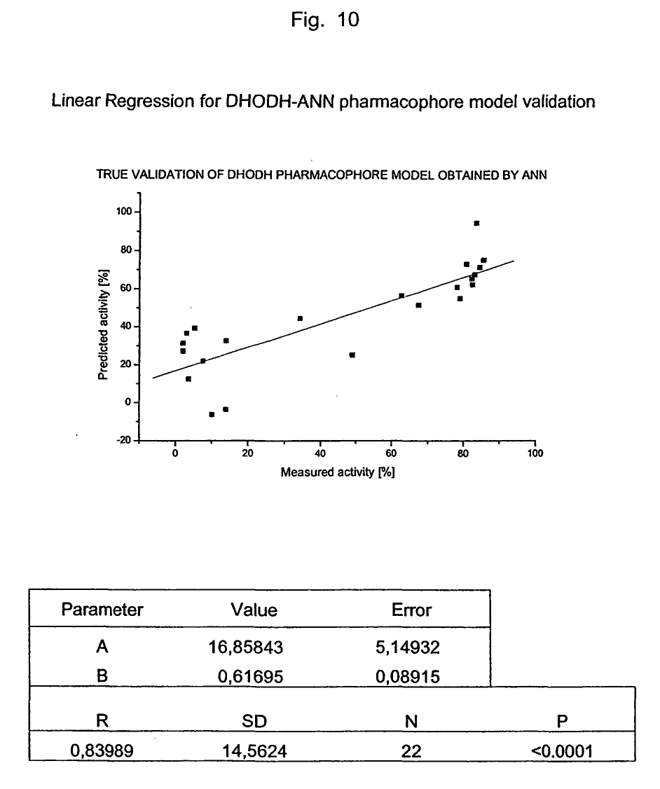

FIGS. 2 through 10 show the linear regressions between the calculated and experimental values for the investigated biological activities. All the figures show data of external true validations and indicates the modelling power one can obtain with the given descriptors for completely different biological activities and data types and reflects the inherent and usually large experimental error of the biological activity values.

In the figures:

A represents the offset of the regression equation

B represents the slope in the regression equation

R is the correlation coefficient

SD stands for the Standard Deviation of the regression

N is the number of molecules in the external validation set

P is the probability that the obtained correlation is only a chance correlation. P was determined using the Fisher's F ratio statistics.

### Example 2

### Epidermal Growth Factor Receptor Tyrosine Kinase Inhibitors

Analysis of EGFRTK (epidermal growth factor receptor tyrosine kinase) inhibitors collected from the scientific literature. EGFRTK inhibitory data were collected for 647 compounds from the scientific literature. This set represents a wide variety of chemical structure families. The log(1/IC₅₀)=pIC₅₀ values were reproduced or predicted. The 647 molecules were divided into a 600-molecule working set and into a 47-molecule validation set. The results of the pIC₅₀ calculations are summarized in Table 3 where the maximized average Q² for the monitoring validation sets and the Q² values of the final model validations are displayed along with the model parameters and important descriptors.

TABLE 3
QSAR model data for EGFRTK inhibitors

| | Model | | |
|---|---|---|---|
| | MLR | PLS | NN |
| Maximum average | 0.597 | 0.586 | 0.592 |
| Q² of monitoring | (average of 32 | (average of 32 | (average of 8 |
| validations | values) | values) | values) |
| Q² of final external | 0.620 | 0.507 | 0.645 |
| validation | | | |
| Model parameters | 23 parameters | 25 parameters, | 6 hidden neurons, |
| | | 18 components | 372 parameters, |
| | | | ρ = 1.61 (at 600 |
| | | | compounds) |

| | |
|---|---|
| Common | Surface, HB donor surface area (1), unsaturation |
| descriptors that | number, electrostatic acidity, electrostatic total |
| appear in at least 2 | basicity, Randic index, gravitational index, sum |
| optimized models | of O charges (QO), C(sp2)-electrotopologic index |
| | pair correlation, N(sp2)-localized charges pair |
| | correlation, electrotopological index |
| | autocorrelation |

Demonstration of External Validation of EGFRTK Pharmacophore Models:

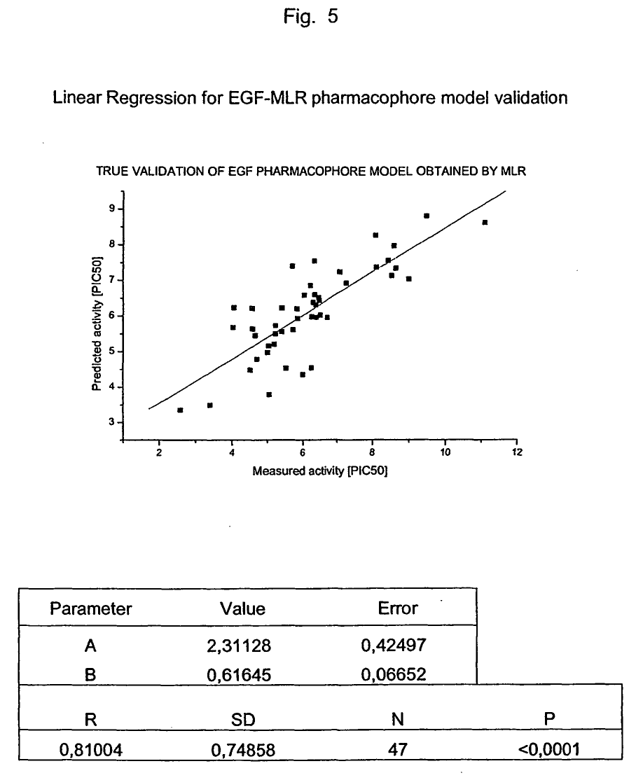

Visualized in FIGS. 5, 6, and 7 are the validation data of the final model obtained by MLR, PLS, and ANN respectively, with an external validation set which was excluded from the model building.

### Example 3

### Analysis of Literature DHODH Data and Data Measured by the Applicant

Percentage of inhibition data at 6.25 μM concentration for 128 compounds from databases of the applicant were used [COMPOUNDS.DB, 2000, VICHEM Ltd., Hungary/AXXIMA Pharmaceuticals AG, Germany]. These data were augmented with 164 data collected from the literature. The inhibition figures were approximated from the IC₅₀ and Kᵢ data by using the “logit” transformation. The 292 molecules were separated randomly into a 270-molecule working set and a 22-molecule final validation set. The percentage of inhibition at 6.25 μM was calculated. Table 4 contains the maximised monitoring Q² values and the Q² values of the final cross validation.

TABLE 4
QSAR model data for DHODH inhibitors

| | Model | | |
|---|---|---|---|
| | MLR | PLS | NN |
| Maximum average | 0.513 | 0.600 | 0.553 |
| Q² of monitoring | (average of 32 | (average of 32 | (average of 8 |
| validations | values) | values) | values) |
| Q² of final external | 0.276 | 0.439 | 0.478 |
| validation | | | |
| Model parameters | 19 parameters | 21 parameters, | 5 hidden neurons, |
| | | 5 components | 145 parameters, |
| | | | ρ = 1.86 (at 270 |
| | | | compounds) |

| | |
|---|---|
| Common | Polarizability, degree of rotational freedom, |
| descriptors that | HB donor surface area (1), Wiener index, Randic |
| appear in at least 2 | index, sum of O and N charges (QNO), |
| optimized models | electrotopological index, HB donor H- C(sp2) |
| | pair correlation, C(sp2)-loc. Charge pair |
| | correlation, atomic vdw volume-lipohilicity |
| | contribution pair correlation |

Demonstration of a Single External Validation of DHODH Pharmacophore Models:

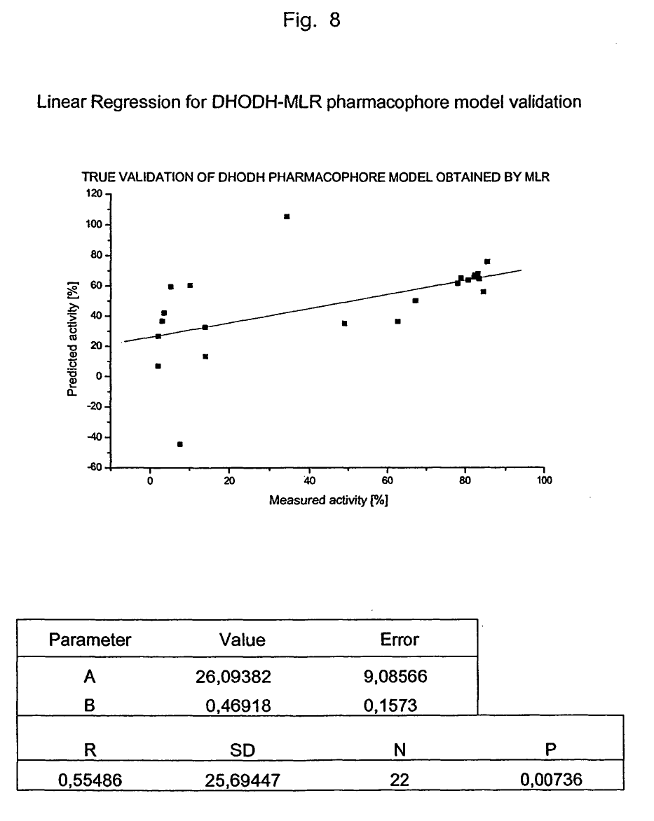

Visualized in FIGS. 8, 9, and 10 are the validation data of the final model obtained by MLR, PLS, and ANN respectively, with an external validation set which was excluded from the model building.

### Example 4

### Predictive Ability for Different Chemical Scaffolds

If the initial descriptor pool contains a large number of not chemical skeleton specific descriptors and the said optimisation process is driven by using prediction-oriented tests there is a definite chance to find molecular scaffold independent QSAR models.

We demonstrate this here with the same EGFRTK receptor inhibition data as used in the 2. example. In that example the external validation set was randomly selected. Here we systematically removed from the workset all the benzylamines (I, 45 molecules), all the flavonoids (II, 7 molecules) and all the quinolines (III, 5 molecules).

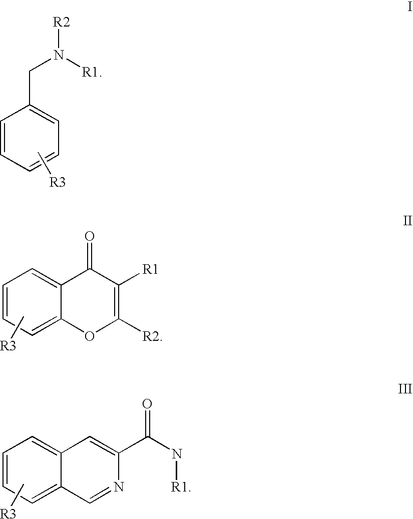

These altogether 57 molecules were used as external validation set for the optimised model in this example. This model was automatically developed with the said method from the structure-activity data of the remaining 590 molecules. These molecules represent other chemical scaffolds than those of collected in the external validation set.

An ANN model was developed with the said continuous hidden neuron number inner optimisation during the automatic variable subset selection. In the model definition we started with 1322 descriptors. No functional group contributions or similar chemical skeleton specific descriptors were used. The 590 molecules work set was randomly separated into 295 molecules training and 295 molecules evaluation set. This random split-half separation was repeated 8 times. These types of tests where the same or less number of molecules are predicted as used in the model generation measure the predictive ability of the given models in stringent conditions. The average predictive Q² over this 8 members validation ensemble was maximized during the said automatic QSAR model optimisation. Genetic Algorithm with the said double Roulette-Wheel selection of the chromosomes was used for optimisation. One generation contained 12 chromosomes and 24 offspring were generated during evolution of the models. Model evolution was stopped when the best model was the same during the last 10 generations. After evaluating 35 generations a 14 descriptor/6 hidden neuron ANN model was obtained with the said model optimisation method.

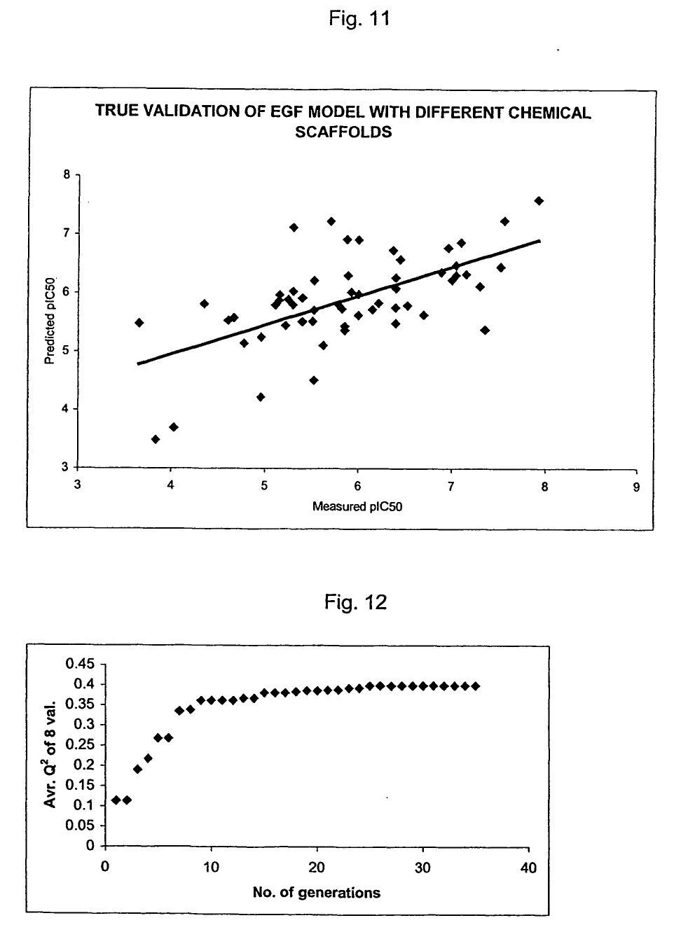

The statistical parameters of the external validation (see FIG. 11) of the final ANN model with the 57 molecules of the unseen chemical scaffolds were:

Predictive Q²=0.2458

SEP=0.7739

Spearman's Rank Corr.=0.5590

TOP25% Hit Ratio=57.1%

BOTTOM25% Hit Ratio=46.7%

The activity trends and more than 50% of the hits in the upper quartile for the new scaffolds are well predicted. Especially the 2 molecules with the highest activity in this external validation set are well assigned. The absolute values of the activities are, however, less well estimated. This is however expectable since the prediction oriented simple QSAR model focuses on general trends of the given quantitative structure activity relation. In other words the differences between activities within a family of compounds are estimated better than the absolute activity values for the individual compounds.

The automatically selected descriptors along with their importance score in the final ANN EGF model were:

| | |
|---|---|
| Gu | 100% (G total symmetry index/unweighted WHIM |
| | descriptors) |
| R8p+ | 47% (R maximal autocorr. of lag 8/weighted by atomic pol.) |
| X1Av | 45% (average valence connectivity index chi-1) |
| E2s | 25% (2nd component accessibility directional WHIM index) |
| R4v+ | 24% (R max. autocorrelation of lag 4/weighted by vdW |
| | volume) |
| P1p | 15% (1st comp. directional WHIM index/weighted by |
| | atomic pol.) |
| HATS0u | 11% (leverage-weighted autocorrelation of lag 0) |
| MATS5p | 6% (Moran autocorr. lag 5/weighted by atomic pol.) |
| BENp6 | 4% (neg. Burden eigenvalue n. 6/weighted by atomic pol.) |
| HATS4e | 4% (lev.-weighted autocorr. of lag 4/weighted by |
| | electroneg.) |
| GGI5 | 2% (Galvez topological charge index of order 5) |
| BENm8 | 2% (neg. Burden eigenvalue n. 8/weighted by atomic mass) |
| R1e | 1% (R autocorr. of lag 1/weighted by electroneg.) |
| GATS7v | 1% (Geary autocorr. lag 7/weighted by atomic vdW |
| | volume) |

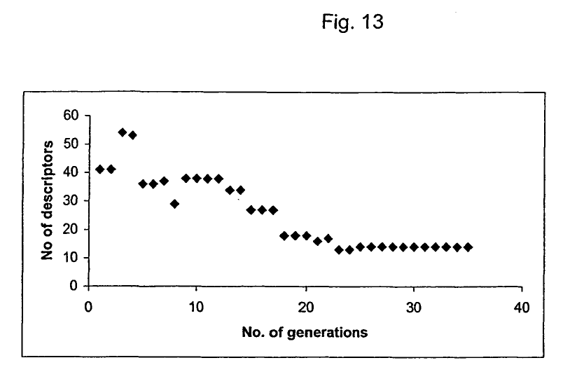

These descriptors are mainly autocorrelation and WHIM types and are similar and partly identical to those obtained for the EGFRTK inhibition models in Example 2. They display the importance of the 3D distribution of atomic polarizabilities, electro negativities and steric properties of the constituting atoms in the EGFRTK QSAR models. The improvement of the average Q² of the actual best method is shown in FIG. 12 along with the number of descriptors in those models (FIG. 13).

Discussion of the Results:

The QSPAR models developed with the automatic descriptor selection and intensive cross-validation gave good final validation results. The Q² figure of the monitoring cross-validations may be a good indicator of the inherent error of the data. When a Gaussian distributed random noise with unity standard deviation was added to the DHF inhibition pIC₅₀ values a significant decrease of the corresponding Q² figures of the new optimised models was observed. The monitoring Q² values dropped below 50% of their original value. Even the models with the moderate Q² figures for the DHODH inhibitor data can be used to enhance the possibility of selecting the active compounds from a library. At each model the predicted top 11 molecules in the 22-molecule validation set contained the actual best 6 molecules in the validation set. In other words with half as many tests or synthesis there is an increased probability to find the lead compounds. The probability that such random selection of 11 molecules from 22 will contain the best 6 molecules is the same probability that from a sack that contains 16 black pebbles and 6 white pebbles 11 drawing without reinsertion will yield all the 6 white ones, i.e. 0.0062.

1. A method for generating a quantitative structure property activity relationship between the structure of chemical compounds and their pharmacological activity, said method comprising:
a) establishing at least on database containing molecular descriptors especially 2D and/or 3D biological/physical/chemical date;
b) providing at least a model for generating a quantitative structure property activity relationship;
c) selecting significant descriptors according to their influence to said structure property activity relationship;
d) verifying said model by the use of at least on quality parameter; and
e) repeating steps b, c, and d until said quality parameter reaches a predetermined value.

2. The method according to claim 1 wherein a neural network is used for the generation of a quantitative structure property activity relationship between the structure of chemical compounds and their pharmacological activity.

3. The method according to claim 1 or 2 wherein said method can be used for generating a quantitative structure property activity relationship of chemical compounds with no close relation or no relation in chemical structure.

4. The method according to claim 2 wherein the 2D biological/physical/chemical data are converted to 3D data.

5. The method according to claim 2 wherein said selection of significant descriptors is user defined.

6. The method according to claim 2 wherein said selection of significant descriptors comprises a ranking of said significant descriptors according to their influence to said structure property activity relationship.

7. The method according to claim 2 wherein said model is a quantitative structure property activity relationship (QSPAR) model for simultaneous, automatic application of Partial Least Squares (PLS), Multivariate Linear Regression (MLR) and/or Artificial Neural Networks (ANN) algorithms.

8. The method according to claim 2 wherein said selection of significant descriptors includes sequential and/or genetic algorithms.

9. The method according to claim 8 wherein the genetic algorithm comprises double roulette wheel algorithms.

10. The method according to claim 2 wherein said database is split into a work set and a validation set.

11. The method according to claim 10 wherein the validation set is an external validation set.

12. The method according to claim 10 wherein said work set is divided into a least one training set and at least one test set.

13. The method according claim 2 wherein said quality parameter is a cross-validated correlation coefficient or a standard error prediction factor or a Spearman's Rank Comparison Coefficient or a TOP25% hit factor or a BOTTOM25% hit factor.

14. The method according to claim 1 wherein said method can be speeded up by user intervention.

15. The method according to claim 2 wherein the experimentally verified data of the pharmacologically active compounds found by said method can be added to said database and can be used for obtaining improved quantitative structure property activity relationships by repeating said method.

16. A system for generating a quantitative structure property activity relationship between the structure of the chemical compounds and their pharmacological activity, said system comprising:
a) at least one database unit containing molecular descriptors especially 2D and/or 3D biological/physical/chemical data;
b) a selection unit for selecting significant descriptors according to their influence to said structure property activity relationship;
c) a model unit containing at least a model for generating a quantitative structure property activity relationship;
d) a quality unit containing at least one quality parameter for measuring the goodness of the generated structure property activity relationship; and
e) a optimization unit for controlling the selection unit and the model unit so that said quality parameter reaches a predetermined value.

17. The system according to claim 16 further comprising a menu driven software shell.

18. The system according to claim 17 wherein the 2D pharmacological and/or chemical data are converted to 3D data.

19. The system according to claim 17 wherein said model further comprises Partial Least Squares (PLS), Multivariate Linear Regression (MLR) and/or Artificial Neural Networks (ANN) algorithms and at least one validation algorithm.

20. The system according to claim 17 wherein said selection unit comprises a ranking unit for ranking said significant descriptors according to their influence to said structure property activity relationship.

21. The system according to claim 17 wherein said selection unit comprises sequential and/or genetic algorithms.

22. The system according to claim 21 wherein said genetic algorithm comprises double roulette wheel algorithms.

23. The system according to claim 17 wherein said database comprises a work set and a validation set.

24. The system according to claim 23 wherein said work set further comprises at least one training set and at least one test set.

25. The system according to claim 17 wherein said quality parameter comprises a cross-validated correlation coefficient or a standard error prediction factor.

26. A computer program product stored on a computer readable medium for performing the method of claim 1 when said program is run on a computer.
